(19) United States
(12) Patent Application Publication
(10) Pub. No.: US 2006/0245813 A1
(43) Pub. Date: Nov. 2, 2006

(54) Nib-concealing mechanism for retractable writing instruments

(76) Inventor: Kent D. Murphy, New Martinsville, WV (US)

Correspondence Address: Kent D. Murphy, HC 60 Box 314, New Martinsville, WV, 26155-9504, US

(21) Appl. No.: 11/401,473

(22) Filed: Apr. 11, 2006

Related U.S. Application Data
(60) Provisional application No. 60/675,072, filed on Apr. 27, 2005.

(51) Int. Cl. B43K 7/12

(52) U.S. Cl. 401/107

(57) ABSTRACT

A nib-concealing mechanism for retractable writing instruments has a rubber sleeve that fits into the barrel of the writing instrument, the sleeve having: a triangular extension that extends into the tapered end of the barrel; a writing nib aperture in the triangular extension; and, flaps that are biased to conceal the writing nib aperture. The writing instrument's writing nib is normally concealed under the flaps within the writing nib aperture, but the flaps will flex to allow the writing nib to extend out of the writing instrument. When the writing nib is retracted back into the writing nib aperture, the flaps will resiliently re-conceal the writing nib in the writing nib aperture.

### CROSS-REFERENCE TO RELATED APPLICATIONS

U.S. provisional patent application No. 60/675,072, filed Apr. 27, 2005.

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

The present invention seeks to provide a nib-concealing mechanism that enables writing instruments with fine point nibs, such as fine line markers, to be made retractable by providing a mechanism that fits into the tapered end of the writing instrument and conceals the nib of the writing instrument when the nib is retracted. At present, these types of writing instruments, which use writing fluids that can evaporate, have troublesome caps that must be removed to expose the nib prior to use, and than replaced after use. If these caps are misplaced or lost, the nib of the writing instrument will dry out, thus rendering the writing instrument useless.

At present, certain writing instruments, known as “permanent markers,” that use similar evaporation-prone writing fluid have been made retractable, but these instruments have large nibs, and the nib-enclosing mechanisms they use are more complex than the present invention, and may not be suitable for adaption to writing instruments with fine nibs. These retractable “permanent markers” are: the “Sharpie RT Retractable,” made by Sanford, which conceals the nib in a plastic “safety seal valve” that has a single flap that, through a complex connection, utilizes the resiliency of the retractable instrument's metal retraction spring to close the flap over the nib when the nib is retracted, and; the “Marks-A-Lot Retractable,” made by Avery Dennison, which conceals the nib in a rubber tube and uses a metal spring that pinches the tube to close the tube over the nib when the nib is retracted.

### BRIEF SUMMARY OF THE INVENTION

More particularly, the invention is to provide a one-piece rubber nib-concealing mechanism that fits into the tapered end of a retractable writing instrument having a fine point nib, the nib-concealing mechanism having: a longitudinal bore through which the writing fluid cartridge of the writing instrument can slide; a flange that fits around the cartridge, and; a pair of resilient flaps that normally conceal the writing nib on the cartridge, but which will flex to allow the nib to extend, and then resiliently return to form and re-conceal the nib when the nib is retracted.

Further, the invention is intended to provide an easy-to-manufacture nib-concealing mechanism that achieves maximum efficiency by exploiting the properties of rubber and the tapered design of the barrel of the writing instrument to allow the mechanism to work without the use of a metal spring, while also making it suitable for writing instruments with fine point nibs.

Other features and advantages of the invention will become apparent during the course of the following detailed description.

### BRIEF DESCRIPTION OF THE SEVERAL VIEWS OF THE DRAWINGS

FIG. 1 is a side elevation view of a retractable writing instrument with the barrel cutaway, the writing instrument being retracted such that the nib is concealed within a nib-concealing mechanism.

FIG. 2 is a enlarged diagonal elevation view of the nib-concealing mechanism prior to the mechanism being inserted into the barrel of the writing instrument.

FIG. 3 is a partially cutaway view similar to FIG. 2.

FIG. 4 is an enlarged fragmentary view of FIG. 1.

FIG. 5 is a partially cutaway view similar to FIG. 4.

FIG. 6 is a view similar to FIG. 1 showing the writing nib extended.

FIG. 7 is a view similar to FIG. 4 showing a partially cutaway view of a second embodiment of the invention.

FIG. 8 is a view similar to FIG. 7 showing a third embodiment of the invention.

### DETAILED DESCRIPTION

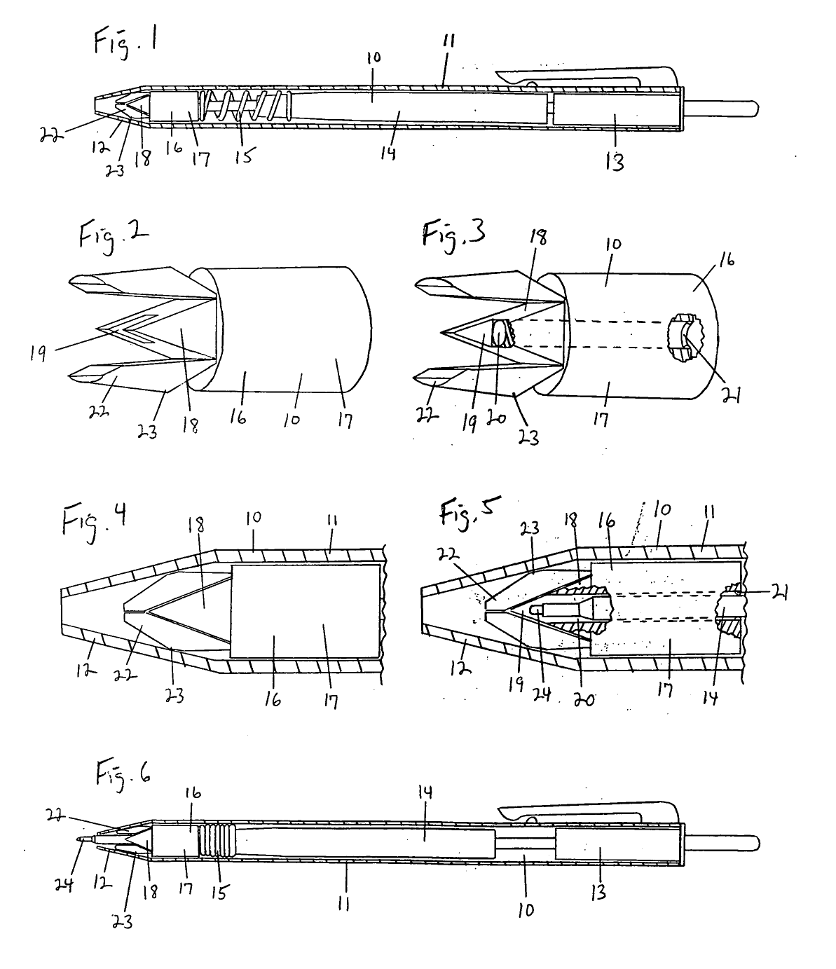

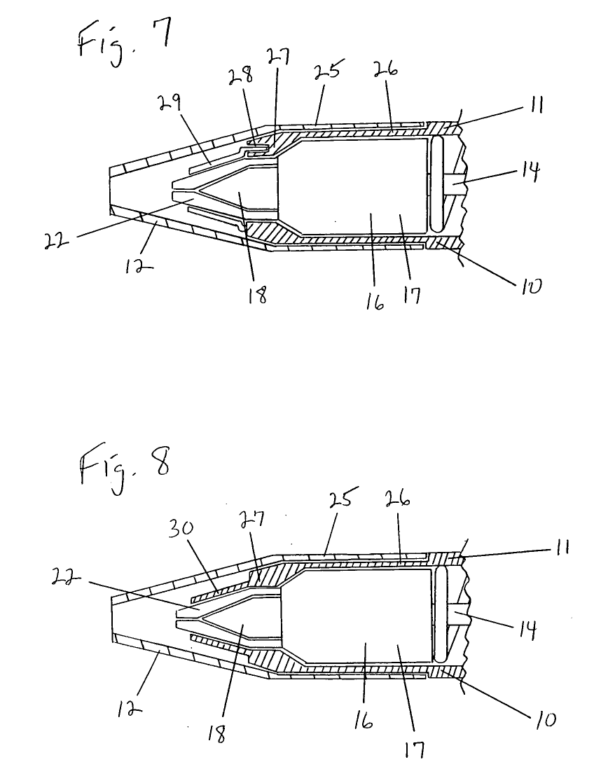

Referring to the drawings in detail wherein like numerals designate like parts, and referring initially to FIGS. 1 through 6, a nib-concealing mechanism for retractable writing instruments.

A nib-concealing mechanism 16 is a one-piece rubber mechanism 16 having: a longitudinal cylinder 17; a triangular extension 18 centrally disposed at one end of said cylinder 17; a bore 20 that passes longitudially through the center of said cylinder 17 and said triangular extension 18; a flange 21 in said bore 20 at the end of said cylinder 17 opposite said triangular extension 18; an aperture 19 centrally disposed at the apex of said triangular extension 18 created by passage of said bore 20 through said triangular extension 18; a pair of flaps 22 connected to said cylinder 17 on opposite sides of said triangular extension 18, said flaps 22 when manufactured and prior to assembly into a writing instrument 10 being spaced apart from from said triangular extension 18, and; raised areas 23 centrally disposed on the sides of said flaps 22 opposite said triangular extension 18.

A retractable writing instrument 10 incorporating the aforesaid nib-concealing mechanism 16 has an elongate barrel 11, one end of said barrel 11 being a tapered end 12, and when said retractable writing instrument 10 is being assembled the aforesaid nib-concealing mechanism 16 is inserted into the end of said barrel 11 opposite said tapered end 12 and pushed through said barrel 11 until the aforesaid raised areas 23 on the aforesaid flaps 22 are forced against said tapered end 11 such that said flaps 22, hitherto being spaced apart from the aforesaid triangular extension 18, are forced to abut upon said triangular extension 18 and the opposite said flap 22, thereby concealing the aforesaid aperture 19 in said triangular extension 18. Then, in this sequence, a coil spring 15, a writing fluid cartridge 14, and a retracting mechanism 13 are inserted into the end of said barrel 11 opposite said tapered end 12. After said retractable writing instrument 10 is assembled: said coil spring 15 abuts upon said nib-concealing mechanism 16; said cartridge 14 abuts upon and passes through said coil spring 15 and into the aforesaid bore 20 through said nib-concealing mechanism 16 such that the aforesaid flange 21 fits around said cartridge 14, said coil spring 15 normally biasing said cartridge 14 to be held in a position relative to said nib-concealing mechanism 18 such that a writing nib 14 at the end of said cartridge 14 is positioned in said aperture 19 in said triangular extension 18, where it is concealed by said flaps 22, and; said retracting mechanism 13 is securely fitted into the end of said barrel 11 opposite said tapered end 12, said retracting mechanism 13 operably engaging said cartridge 14.

The aforesaid flaps 22 normally concealing the aforesaid aperture 19 in the aforesaid triangular extension 18 in which is normally positioned the aforesaid writing nib 24 are flexible and resilient, said flaps 22 flexing to allow the aforesaid writing nib 24 to extend out of the aforesaid tapered end 12 of the aforesaid barrel 11 when the aforesaid retracting mechanism 13 is operated to extend said writing nib 24, and, after said retracting mechanism 13 is operated to retract said writing nib 24 to its said normal position within said aperture 19, said flaps 22 resiliently re-conceal said aperture 19 and said writing nib 24 within therein.

FIG. 7 shows a second embodiment of the invention in which the aforesaid raised areas 23 on the aforesaid flaps 22 are eliminated, and the aforesaid barrel 12 is divided into two pieces, said barrel 12 and a separate tapered end piece 13 that fits over a reduced diameter section 26 of said barrel 12, inside said reduced diameter section 26 there being opposing spring anchors 27 having spring sockets 28 in which are fitted metal springs 29 that function to force said flaps 22 to abut upon the aforesaid triangular extension 18 so as to conceal the aforesaid aperture 19, and to resiliently re-conceal said aperture 19 when the aforesaid writing tip 24 is retracted back into said aperture 19.

FIG. 8 shows a third embodiment of the invention in which the aforesaid spring sockets 28 and the aforesaid metal springs 29 are eliminated and are replaced by plastic springs 30 that are integrally molded onto the aforesaid spring anchors 27.

As required, detailed embodiments of the present invention are disclosed herein; however, it is to be understood that the diclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

I claim:

1. A nib-concealing mechanism for retractable writing instruments comprising:
a) a sleeve, said sleeve inside the barrel of said writing instrument, the writing fluid cartridge of said writing instrument slidable within said sleeve;
b) a writing nib aperture, said writing nib on said writing fluid cartridge normally in said writing nib aperture;
c) flap-like concealing means, said flap-like concealing means biased to normally conceal said writing nib aperture, said flap-like concealing means movable to allow said writing nib to extend out of said barrel of said writing instrument, and said flap-like concealing means biased to re-conceal said writing nib aperture when said writing nib is retracted back into said writing nib aperture; and,
d) cooperative connection, there being a cooperative connection between said barrel and said flap-like concealing means so as to effect said biasing of said flap-like concealing means.

2. A nib-concealing mechanism for retractable writing instruments as defined in claim 1, there being resilient means, said resilient means flexing to allow said extension of said writing nib and retracting to effect said biasing of said flap-like concealing means to re-conceal said writing nib aperture after said retraction of said writing nib.

3. A nib-concealing mechanism for retractable writing instruments as defined in claim 1, said sleeve having a tapered portion extending into said tapered end of said barrel of said writing instrument.

4. A nib-concealing mechanism for retractable writing instruments as defined in claim 3, said writing nib aperture in said tapered portion of said sleeve.

5. A nib-concealing mechanism for retractable writing instruments as defined in claim 3, said tapered portion of said sleeve being triangular in shape.

6. A nib-concealing mechanism for retractable writing instruments as defined in claim 1, there being multiple said flap-like concealing means.

7. A nib-concealing mechanism for retractable writing instruments comprising:
a) a sleeve, said sleeve inside the barrel of said writing instrument, the writing fluid cartridge of said writing instrument slidable within said sleeve;
b) a writing nib aperture, said writing nib on said writing fluid cartridge normally in said writing nib aperture;
c) a tapered portion, said sleeve having a tapered portion extending into said tapered end of said barrel of said writing instrument; and,
d) flap-like concealing means, said flap-like concealing means biased to normally conceal said writing nib aperture, said flap-like concealing means movable to allow said writing nib to extend out of said barrel of said writing instrument, and said flap-like concealing means biased to re-conceal said writing nib aperture when said writing nib is retracted back into said writing nib aperture.

8. A nib-concealing mechanism for retractable writing instruments as defined in claim 7, said writing nib aperture in said tapered portion of said sleeve.

9. A nib-concealing mechanism for retractable writing instruments as defined in claim 7, said tapered portion of said sleeve being triangular in shape.

10. A nib-concealing mechanism for retractable writing instruments as defined in claim 7, there being a cooperative connection between said barrel and said flap-like concealing means so as to effect said biasing of said flap-like concealing means.

11. A nib-concealing mechanism for retractable writing instruments as defined in claim 7, there being resilient means, said resilient means flexing to allow said extension of said writing nib and retracting to effect said biasing of said flap-like concealing means to re-conceal said writing nib aperture after said retraction of said writing nib.

12. A nib-concealing mechanism for retractable writing instruments as defined in claim 7, there being multiple said flap-like concealing means.
